(19) United States
(12) Patent Application Publication
(10) Pub. No.: US 2008/0156767 A1
(43) Pub. Date: Jul. 3, 2008

(54) Method for fabricating image sensor

(75) Inventors: Ki Jun Yun, Suwon-si (KR); Sang Il Hwang, Wonju-si (KR)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Dongbu HiTek Co., Ltd.

(21) Appl. No.: 12/001,629

(22) Filed: Dec. 11, 2007

(30) Foreign Application Priority Data
Dec. 29, 2006 (KR) 10-2006-0138961

(51) Int. Cl. B29D 11/00

(52) U.S. Cl. 216/26

(57) ABSTRACT

Provided is a method for fabricating an image sensor. In the method, a low temperature oxide layer is formed on a color filter layer, and a photoresist pattern is formed on the low temperature oxide layer. Subsequently, a heat treatment is performed on the photoresist pattern to form sacrificial microlenses. The sacrificial microlenses and the low temperature oxide layer are etched to form preliminary microlenses formed the low temperature oxide layer. The preliminary microlenses are etched to form microlenses having a reduced curvature radius in comparison with that of the preliminary microlenses.

### CROSS-REFERENCE TO RELATED APPLICATIONS

The present application claims priority under 35 U.S.C. 119 and 35 U.S.C. 365 to Korean Patent Application No. 10-2006-0138961 (filed on Dec. 29, 2006), which is hereby incorporated by reference in its entirety.

Embodiments of the present invention relate to an image sensor and a manufacturing method thereof. An image sensor is a semiconductor device for converting optical images into electrical signals. One of challenges to be solved in fabricating an image sensor is to increase a rate of converting incident light signals into electrical signals (i.e., sensitivity).

A variety of methods for realizing a zero gap allowing no gap to be generated between adjacent microlenses forming a microlens array has been proposed in forming the microlenses for condensing light.

While microlenses are formed using a photoresist, particles such as polymer may attach on the microlenses during a wafer back grinding process and a sawing process. The particles on the microlenses not only reduce the sensitivity of an image sensor but also reduce manufacturing yield because of difficulty in cleaning the microlenses. Accordingly, a variety of methods for forming a microlens using a low temperature oxide (LTO) layer have been tried.

Also, the profile of a microlens has a direct influence on a focal length of a microlens. Therefore, a method reducing the curvature radius of microlenses and, consequently, the focal length of the microlenses may allow a reduction in the overall size of an image sensor device.

### SUMMARY

Embodiments of the present invention provide a method for fabricating an image sensor, that can improve the sensitivity of an image sensor device and reduce the size of the device by reducing a light-condensing distance (i.e., focal length).

In one embodiment, a method for fabricating an image sensor includes: forming a low temperature oxide layer on a color filter layer; forming photoresist patterns on the low temperature oxide layer; performing heat treatment on the photoresist patterns to form sacrificial microlenses; primarily etching the sacrificial microlenses and the low temperature oxide layer to form preliminary microlenses formed of the low temperature oxide layer; and secondarily etching the preliminary microlenses to form microlenses having a reduced curvature radius in comparison with that of the preliminary microlenses.

### BRIEF DESCRIPTION OF THE DRAWINGS

FIG. 1 is a cross-sectional view illustrating a method for fabricating an image sensor according to one embodiment, wherein sacrificial microlenses 15 are formed over a low temperature oxide layer 13.

FIG. 2 is a cross-sectional view illustrating a method for fabricating an image sensor according to one embodiment, wherein low temperature oxide layer 13 is etched to form preliminary microlenses 13a.

FIG. 3 is a cross-sectional view illustrating a method for fabricating an image sensor according to one embodiment, wherein preliminary microlenses 13a are etched to form microlenses 13b.

FIG. 4 is a cross-sectional view of a conceptual image sensor according to one embodiment, having a reduced curvature radius and a reduced focal length.

FIG. 5 is a cross-sectional view illustrating an image sensor according to one embodiment, wherein the image sensor includes a gap-reducing layer 17.

FIG. 6 is a graph explaining process conditions in a method for fabricating an image sensor, wherein an etch selectivity ratio of low temperature oxide to photoresist is dependent on the amount of O₂ gas in an etching atmosphere.

### DETAILED DESCRIPTION OF THE EMBODIMENTS

In the description of the embodiments of the present invention, it will be understood that, when a layer (or film), a region, a pattern, or a structure is referred to as being “on/above” or “under/below” another substrate, another layer (or film), another region, another pad, or another pattern, it can be directly on the other substrate, layer (or film), region, pad, or pattern, or intervening layers may also be present. Furthermore, it will be understood that, when a layer (or film), a region, a pattern, a pad, or a structure is referred to as being “between” two layers (or films), regions, pads, or patterns, it can be the only layer between the two layers (or films), regions, pads, or patterns, or one or more intervening layers may also be present. Thus, it should be determined by technical idea of the invention.

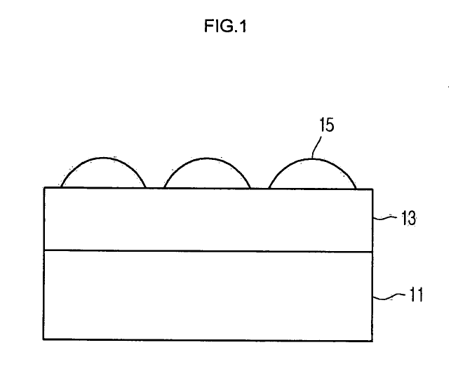

Hereinafter, embodiments of the present invention will be described in detail with reference to the accompanying drawings. FIGS. 1 to 3 are cross-sectional views illustrating a method for fabricating an image sensor according to embodiments of the present invention.

According to the method, a low temperature oxide (LTO) layer 13 is formed on a lower structure 11, and then sacrificial microlenses 15 are formed on the LTO layer 13 as illustrated in FIG. 1.

The lower structure 11 can include photodiodes. The lower structure 11 can further include a color filter layer over the photodiodes, and a planarization layer formed on or over the color filter layer. In order to avoid damage to the underlying structures of the color filter layer, which may comprise photoresist, and the planarization layer, the processes for forming microlenses thereover are preferably performed at a temperature less than about 250° C.

The sacrificial microlenses 15 can be formed using a photoresist. For example, the sacrificial microlenses 15 can be formed by forming a photoresist pattern on the LTO layer 13, and performing heat treatment such as a thermal reflow on the photoresist patterns. The photoresist pattern may be formed by depositing a photoresist material (e.g., polymer photoresist) by a conventional method (e.g., spinning the photoresist on the substrate) and subsequently treating the photoresist by heat-treating the photoresist layer (e.g., by thermal reflow at a temperature of from about 120 to about 250° C., for example from about 150 to about 200° C.). The thermal reflow also causes the photoresist material to form convex or curved portions on its surface, and may cause the photoresist layer to harden, resulting in formation of sacrificial microlenses 15.

The LTO layer includes various oxide layers formed in temperatures below about 200° C. For example, the LTO layer can comprise or be formed of SiO₂ (e.g., a plasma silane-based oxide, a TEOS-based oxide, etc.). Other oxides that can be processed at temperatures below 250° C. may also be used. The oxide layers may be formed by chemical vapor deposition (CVD, which may be plasma-enhanced [PECVD or HDPCVD], or at low pressure [LPCVD]), or blanket deposition.

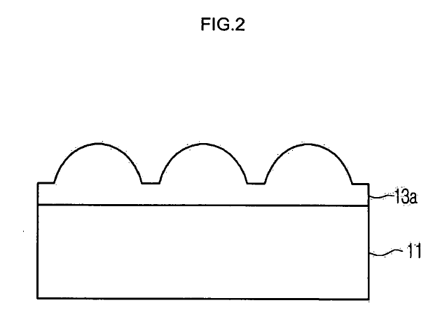

Subsequently, according to a method for fabricating an image sensor according to one embodiment, preliminary microlenses 13a formed of the LTO layer are formed by etching the sacrificial microlenses 15 and the LTO layer 13 as illustrated in FIG. 2. The sacrificial microlenses 15 and the LTO layer 13 are etched by a non-selective (e.g., having an etch selectivity of about 1:1 for the sacrificial microlenses to the transparent material), directional (e.g., anisotropic) etching. The profile of sacrificial microlenses 15, including the convex microlens topology, is substantially transferred to the etched LTO layer 13 (i.e., the preliminary microlenses 13a). As a result, the microlenses 13a may be formed in the LTO material.

Thus, the sacrificial microlenses 15 and the LTO layer 13 can be etched by a blanket etching process with an etching ratio of about 1:1. The etching of the sacrificial microlenses 15 and the LTO layer 13 can be performed until the microlenses 15 are completely removed.

The etching of the sacrificial microlenses 15 and the LTO layer 13 can be performed using an etching gas including a (hydro)halocarbon compound and an oxygen source gas. The (hydro)halocarbon may be a gas having the formula CH_{y}X_{4-y} (where y ≦2, and X is a halogen: F, Cl, Br, and/or I). Preferably, the (hydro)halocarbon is CF₄ or CHF₃. The oxygen source gas may comprise O₂, O₃, N₂O, and/or SOₓ. Preferably the oxygen source gas is O₂. During the etching of the sacrificial microlenses 15 and the LTO layer 13, the (hydro)halocarbon (e.g., CF₄) and the oxygen source gas (e.g., O₂) may be introduced into an etching chamber as etching gases at a ratio in a range of 3:1 to 30:1. Preferably the (hydro)halocarbon and oxygen source gas are used at a ratio of 9:1. The (hydro)halocarbon (e.g., CF₄) etching gas can be supplied at 10-30 sccm, and the oxygen source gas (e.g., O₂) can be supplied at 5-20 sccm.

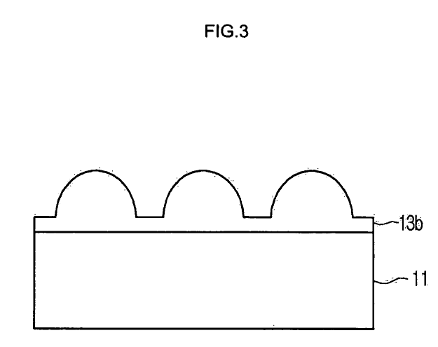

After that, in a method for fabricating an image sensor according to one embodiment, microlenses 13b having a reduced curvature radius compared to that of the preliminary microlenses 13a may be formed by etching the preliminary microlenses 13a as illustrated in FIG. 3.

Etching the preliminary microlenses 13a can be performed using an etching gas as described above, preferably including CF₄ and O₂ at a (flow rate) ratio of about 9:1. Etching the preliminary microlenses 13a includes etching sidewalls of the preliminary microlenses 13a, and the upper surfaces of the preliminary microlenses 13a. Accordingly, the resulting microlenses 13b have a reduced curvature radius as compared to that of the preliminary microlenses 13a.

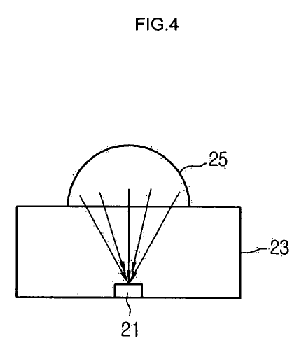

FIG. 4 shows microlenses 25 having a reduced curvature radius and/or focal length, which may result from the foregoing method. Reducing a focal length of light passing through the microlenses 25 reduces a distance between the microlenses 25 and a photodiode 21 (formed in a lower structure 23), on which the microlenses 25 is designed to focus light. The reduced focal length allows an image sensor having a slimmer profile to be formed. FIG. 4 is a conceptual view of an image sensor formed according to the foregoing embodiments.

The above-described primary and secondary etching can be consecutively performed in the same chamber. Also, the primary and secondary etching can be performed in a chamber using dual power frequencies. For example, the etching both the sacrificial microlenses 15 and the LTO layer 13, and the preliminary microlenses 13a can be performed under etching conditions using a high plasma ignition power of 1400 W at 27 MHz, and an etching gas that includes CF₄ 90 sccm, O₂ 10 sccm, and Ar 450 sccm. The etching steps may also be carried out with a high bias power (e.g., 2000-10,000 W, for example applied to the wafer chuck) to control ion directionality.

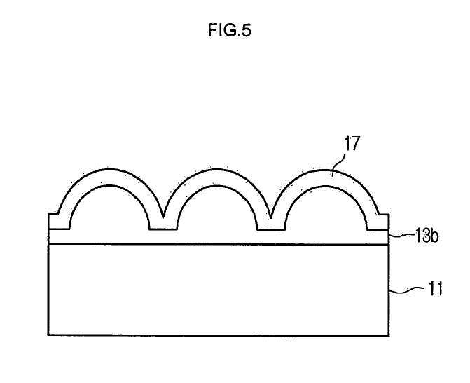

Meanwhile, in an image sensor fabricated according to methods of the present embodiments, a gap can be generated between adjacent lenses forming microlenses. A gap-reducing layer can be formed on the microlenses 13b, as illustrated in FIG. 5. That is, an exemplary method for fabricating an image sensor according to embodiments of the invention forms a gapless layer 17 on the microlenses 13b as illustrated in FIG. 5.

The gap-reducing layer 17 can comprise an oxide material, such as LTO layer. The oxide material may be SiO₂ or another oxide material that may be processed at a temperature below 250° C., for example by a plasma silane (p-Si) method or a TEOS (CVD) method.

The sensitivity of an image sensor device can be further improved even more by reducing or substantially eliminating gaps from being generated between adjacent microlenses forming the microlenses 13b.

Etching process conditions for performing the above-described etching steps will be described hereafter in detail. Since a photoresist and an oxide layer are to be etched, etching may be performed using a fluorine- or halogen-based gas and an oxygen gas. The fluorine/ halogen-based gas can include a gas having the formula CX₄ (wherein X is a halogen: F, Cl, Br, and/or I) or the formula CH_{y}X_{4-y} (wherein y≦2, and X is a halogen: F, Cl, Br, and/or I). Preferably, the fluorine/halogen-based compound is CF₃ or CHF₃. Selectivity between the photoresist and the oxide layer may be controlled by adjusting a ratio of the fluorine/halogen-based gas to the oxygen-based gas. The oxygen-based gas may comprise O₂, O₃, N₂O, and/or SOₓ. Preferably the oxygen source is O₂. Also, plasma ignition and its potential force may be controlled using an Ar gas. The etching steps may also be carried out with a high bias power to control ion directionality.

A dual frequency power may be used to realize the desired microlens shape. For example, dissociation of fluorine is facilitated by using a frequency of 27 MHz, and the potential energy of plasma is increased by using a frequency of 2 MHz. For backside cooling, He gas is supplied to the upper end of a chuck to improve wafer non-uniformity generated during an etching process.

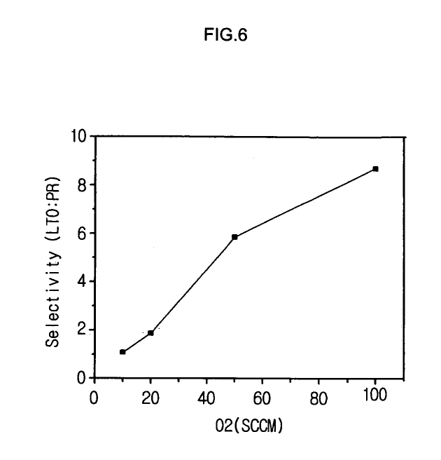

In a method for fabricating an image sensor according to one embodiment, selectivity between a photoresist and an oxide layer is controlled by adjusting a ratio of CF₄ to O₂. Selectivity depending on a ratio change of O₂ is illustrated in FIG. 6. FIG. 6 is a graph explaining process conditions in a method for fabricating an image sensor according to embodiments of the invention.

Referring to FIG. 6, the etching selectivity between a photoresist and an oxide layer is related to an amount of O₂ in the etching chamber. The graph shows etch selectivity values at different O₂ levels, in combination with CF₄ 90 sccm. In a preferred embodiment, etching selectivity between the photoresist and the oxide layer is maintained at about 1:1 by controlling a ratio of CF₄ to O₂.

In one embodiment, the etching can be performed under the following etching conditions of power of 1400 W at 27 MHz, and an etching gas of CF₄ 50 sccm, O₂ 10 sccm, and Ar 490 sccm.

A method for fabricating an image sensor according to the present embodiments improves the sensitivity of a device, and reduces a light-condensing distance. As a result, the size of the image sensor device may be reduced.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for fabricating an image sensor, the method comprising:
forming a low temperature oxide layer on a color filter layer;
forming a photoresist pattern on the low temperature oxide layer;
heating the photoresist pattern to form sacrificial microlenses;
etching the sacrificial microlenses and the low temperature oxide layer to form preliminary microlenses formed in the low temperature oxide layer; and
etching the preliminary microlenses to form microlenses having a reduced curvature radius in comparison with that of the preliminary microlenses.

2. The method according to claim 1, further comprising forming a planarization layer after forming the color filter layer and before forming the low temperature oxide layer.

3. The method according to claim 1, further comprising forming a gap-reducing layer on the microlenses.

4. The method according to claim 3, wherein the gap-reducing layer comprises a second low temperature oxide layer.

5. The method according to claim 1, wherein etching the sacrificial microlenses and the low temperature oxide layer comprises blanket-etching at an etching selectivity of about 1:1.

6. The method according to claim 1, wherein etching the sacrificial microlenses and the low temperature oxide layer is performed until the sacrificial microlenses are completely removed.

7. The method according to claim 1, wherein etching the sacrificial microlenses and the low temperature oxide layer comprises using an etching gas including CF₄ and O₂.

8. The method according to claim 7, wherein the CF₄ and the O₂ are present in the etching gas at a ratio of 3:1-15:1.

9. The method according to claim 7, wherein the CF₄ is supplied at 10-300 sccm, and the O₂ is supplied at 5-20 sccm.

10. The method according to claim 1, wherein etching the preliminary microlenses comprises using an etching gas including CF₄ and O₂.

11. The method according to claim 1, wherein etching the preliminary microlenses comprises etching sidewalls of the preliminary microlenses.

12. The method according to claim 1, wherein the steps of etching the sacrificial microlenses and the low temperature oxide layer and etching the preliminary microlenses are consecutively performed in a same chamber.

13. The method according to claim 1, wherein the steps of etching the sacrificial microlenses and the low temperature oxide layer and etching the preliminary microlenses are performed in a chamber using dual power frequencies.

14. The method according to claim 1, wherein the low temperature oxide layer comprises SiO₂.

15. The method according to claim 3, wherein gaps exist between adjacent microlenses.

16. The method according to claim 15, wherein the gap-reducing layer substantially eliminates the gaps between the adjacent microlenses.

17. The method according to claim 1, wherein the step of etching the sacrificial microlenses and the low temperature oxide layer comprises using a high plasma ignition power and a high bias power.

18. The method according to claim 1, wherein the step of etching the preliminary microlenses comprises using a high plasma ignition power and a high bias power.

19. The method according to claim 1, wherein the reduced curvature radius reduces a focal length of light passing through the microlenses.

20. The method according to claim 1, wherein heating comprises a thermal reflow process at a temperature of about 120 ° C. to about 250° C.
